(19) United States
(12) Patent Application Publication
(10) Pub. No.: US 2026/0347256 A1
(43) Pub. Date: Nov. 5, 2026

(54) RECYCLED CONCRETE/GEOPOLYMER FOR OIL AND GAS ZONAL ISOLATION APPLICATIONS

(71) Applicant: Schlumberger Technology Corporation, Sugar Land, TX (US)

(72) Inventors: Xia Wei, Sugar Land, TX (US); Roderick Pernites, Sugar Land, TX (US)

(21) Appl. No.: 19/665,824

(22) Filed: May 1, 2026

Related U.S. Application Data
(60) Provisional application No. 63/799,109, filed on May 2, 2025.

(51) Int. Cl. C04B 28/00; C04B 18/14; C04B 18/167; C04B 111/00

(52) U.S. Cl. CPC C04B 28/006; C04B 18/141; C04B 18/167; C04B 2111/00146; C04B 2201/52

(57) ABSTRACT

Polysialate compositions and methods of using such compositions to make polysialate systems are described herein. The polysialate compositions generally use a recycled cementitious material as a polysialate raw material. Other polysialate raw materials, such as aluminosilicate sources and alkaline activators, can also be used. These materials can be dispersed in water to form a pumpable polysialate precursor, which can be used to form a polysialate system having suitable compressive strength after curing.

### CROSS-REFERENCE TO RELATED APPLICATIONS

This application claims priority benefit of U.S. Provisional Patent Application Ser. No. 63/799,109 filed May 2, 2025, which is entirely incorporated herein by reference.

### FIELD

This application for patent relates to compositions and methods of making polysialate polymer systems for use where cementitious materials are needed. Specifically, this application relates to compositions and methods for pumpable polysialate systems that use recycled cementitious materials.

### BACKGROUND

Geopolymers are polysialate polymer systems made by polymerizing aluminum, silicon, and oxygen containing materials in a high pH aqueous solution. Such materials are currently being developed to replace conventional cement materials for a variety of applications to avoid the energy budget and environmental impact of preparing conventional cement raw materials. For these reasons, as well as their low cost, industrial waste materials such as slags and ash materials are currently favored as raw materials for making polysialate systems.

Polysialate systems are often made using byproduct materials such as blast furnace slags and fly ash materials. These materials are dispersed in a high pH hydroxide solution to activate polymerization. Strong hydroxide solutions such as sodium hydroxide solution can be difficult to manage. The byproduct materials normally used to make polysialate systems are also often inconsistent. Making polysialate precursors that can be pumped to a target location and then hardened is also challenging. There is a need for polysialate raw materials that can produce polysialate systems meet challenging design parameters from pumpable precursor mixtures.

### SUMMARY

Embodiments described herein provide a dry polysialate precursor composition, comprising a recycled cementitious material; and an aluminosilicate source, an alkaline activator, or both.

Other embodiments described herein provide a method, comprising obtaining a dry polysialate precursor composition, comprising a recycled cementitious material; and an aluminosilicate source, an alkaline activator, or both; dispersing the dry polysialate precursor composition in a water solution to form a pumpable polysialate precursor; pumping the pumpable polysialate precursor into a well; and allowing the pumpable polysialate precursor to harden in the well to form a polysialate system having compressive strength of at least about 100 psi.

Other embodiments described herein provide a method, comprising obtaining a dry polysialate precursor composition, comprising from about 0.1% to about 50% by weight of a recycled cementitious material; and an aluminosilicate source selected from the group consisting of fly ash, metakaolin, GGBS, or a combination thereof; dispersing the dry polysialate precursor composition in a water solution to form a pumpable polysialate precursor; pumping the pumpable polysialate precursor into a well; and allowing the pumpable polysialate precursor to harden in the well to form a polysialate system having compressive strength of at least about 250 psi.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term “about” should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific data points, it is to be understood that inventors appreciate and understand that any data points within the range are to be considered to have been specified, and that inventors possessed knowledge of the entire range and the points within the range.

Regarding chemical formulas, it should be noted that measurements may not conform precisely to the chemical formulas described herein due to various sources of error that can affect real-world testing. The chemical formulas described herein should therefore be understood as expressing the nominal chemical makeup of compounds, where real-world testing may show close, but not exact, conformity to the formulas.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

The methods and compositions described herein are generally useful in subterranean applications, construction applications, and other applications where cementitious materials are commonly used. In some cases, a subterranean wellbore may be used for carbon capture, utilization, and storage (CCUS) and/or for recovery and use of geothermal energy. Geothermal energy is a promising source of renewable energy that captures energy from heat generated or stored within the earth. For example, geothermal energy may be used to perform climate control (e.g., heating, cooling) for structures (e.g., buildings) using heat pumps and/or to generate electricity (e.g., by heating water to generate steam and drive a turbine with the steam). Subterranean wellbores where the methods and compositions described herein may be used may circulate a working fluid that exchanges heat within the earth formation through which the wellbore extends. The working fluid may be circulated to the surface where a surface heat exchanger is used to transfer thermal energy to another fluid used to generate electricity and/or for climate control. After the thermal energy is transferred from the working fluid in the surface heat exchanger, the working fluid is circulated back to the earth formation to continue the cycle.

CCUS facilitates the capture, use, and/or storage of carbon (e.g., carbon dioxide), which has a goal of achieving carbon neutrality and/or net zero carbon emissions (NZE). Carbon capture may include the capture of carbon dioxide from large point sources, such as power plants, refineries, cement plants, other industrial processing plants, or other industrial facilities that use fossil fuels, biomass fuels, or other fuels that generate carbon dioxide. The captured carbon dioxide may be converted into valuable products such as, for example, ethanol, sustainable aviation fuel, chemicals, mineral aggregates, and/or other products. Alternatively, the carbon dioxide may be stored in geologic formations, such as in depleted hydrocarbon reservoirs. The carbon dioxide may be introduced into the earth formation through a wellbore, such as the wellbores described herein. In the earth formation, the carbon in the carbon dioxide may be dispersed in an aqueous phase and stored as carbon dioxide, may be stored in mineral form (e.g., as a carbonate, such as calcium carbonate, magnesium carbonate, iron (II) carbonate), or as another form of carbon. All such applications can benefit from use of the methods and compositions described herein.

Compositions and methods herein use recycled cementitious materials, such as a recycled polysialate material and/or a recycled cement material, as raw materials for making polysialate systems. A polysialate system is a hardened material that incorporates a polysialate polymer, which is a polymer of silicon, aluminum, and oxygen, as the basic structure of the system. The polymer can include other metal ions, such as calcium and magnesium, chemically bonded into the polymer chain, and other ions within the system but not chemically bonded in the polymer chain. As noted above, a polysialate system is made by dispersing aluminum, silicon, and oxygen containing materials in a high pH hydroxide solution, which activates the polymerization reaction that forms the polysialate system.

Herein, cementitious materials such as hardened cements and polysialate systems when recycled and grinded to the right size can be used as raw materials in polysialate precursors. Such materials can function as activators, raising the pH of the polysialate precursor, and/or as polymerization reactants. In some cases, the cementitious materials can be used as the only activator in the polysialate precursor. In other cases, the cementitious materials can be used with other activators.

The recycled cementitious materials herein can be solid materials recovered from prior construction, for example from demolished buildings, bridges, pavements, and other structures. Solid polysialate systems recovered from prior uses can also be used as a raw material for a new polysialate precursor. The solid, previously set, cementitious materials are rendered in a form that is usable in a polysialate raw material blend. Generally, the recycled cementitious materials are subjected to a sizing process to make the materials blendable as a powder or particle mixture.

The recycled cementitious materials may be used to tailor the particle size distribution of the polysialate raw material blend. In addition to the recycled cementitious materials, other solid polysialate raw materials are used in such blends. Recycled cementitious materials can be sized, based on the particle size distribution of other materials in the solid blend, to provide particle size polydispersity to improve rheological properties of the polysialate precursor so that the precursor can be pumped to a desired location for hardening. Tailoring or selecting particle size distribution of the polysialate raw material blend can also control fluid loss in the polysialate precursor made from the polysialate raw materials.

Recycled cementitious materials can be used alone as a raw material for a polysialation reaction or a cement hydration reaction. Thus, a cementing raw material can be 100% recycled cement, recycled concrete, recycled polysialate, or any combination thereof. In other cases, the recycled cementitious materials are typically used in amounts of up to about 65% by weight of the dry polysialate precursor mixture, such as from about 0.1% to about 65%, about 10% to about 50%, for example about 30%. The amount of recycled cementitious material use may depend on slurry density of the polysialate precursor blend to be used. Lower density slurries may be able to use higher amounts of recycled cementitious materials, as a proportion of the dry polysialate precursor. In some cases, a low amount of recycled cementitious material, such as 0.1% to 20% by weight of the dry polysialate precursor, for example 5% to 15% by weight of the dry polysialate precursor, is used. In other cases, a moderate amount, such as 20% to 40% by weight of the dry polysialate precursor, for example 25% to 35% by weight of the dry polysialate precursor, is used. In still other cases, high amounts, such as 40% to 65% by weight of the dry polysialate precursor, for example 50% to 60% by weight of the dry polysialate precursor, is used. Systems using recycled cementitious materials, as described herein, can be hardened to develop suitable compressive strength for most applications that use cementitious materials. Such systems will develop compressive strength of at least about 100 psi, such as at least about 250 psi, for example at least about 500 psi.

Different recycled materials may have different reactivity, and different aluminum, silicon, and oxygen containing reactants also have different reactivity depending on composition, particle size, and crystallinity. It is believed that the reactivity of the recycled cementitious material depends, at least, on the alkalinity of the recycled material, so many cements having high alkalinity may be more reactive as recycled raw materials than most polysialate materials. Reactivity of the recycled cementitious materials results in pH of the polysialate precursor mixture, and to the extent that the recycled cementitious material results in a pH that is too low, additional activators can be added as needed. Thus, recycled cementitious material that has high pH (in aqueous solution) can be used as a polymerization raw material and/or polymerization activator, while material with lower pH can be a suitable raw material when used with other activators to increase pH of the reaction mixture. It is notable that more reactive (amorphous, small particle size) polysialate raw materials, such as GGBS, may be usable with recycled cementitious materials, as activator, that give rise to lower pH, such as 9-10. Such raw materials may be able to polymerize to suitable degree using some recycled polysialate materials. Less reactive raw materials may need more reactive recycled materials, such as high-calcium cements, potentially mixed with other activators.

Types of recycled cements that can be used as activator and/or reactant in a polysialate precursor include cements made according to American Petroleum Institute standards (“API cements”) and cements made according to other standards (“non-API cements”). Previously hardened Portland cement can be used as a recycled cementitious material for the methods herein. Class G cement, and other types of cement, can also be used as a recycled cementitious material for the methods herein. Types of recycled polysialate systems that can be used include those made using aluminosilicates such as GGBS, fly ash, and metakaolin. In general, recycled cementitious materials having high lime or Portlandite content are useful. In some cases, recycled cementitious materials may also have unreacted activators that can be useful. The polysialate system materials used as recycled cementitious materials are polymeric materials containing one or more polymers of aluminum, silicon, and oxygen, i.e. polysialates. The recycled cement materials are mainly calcium silicate polymers. Recycled cementitious materials have different inherent alkalinity, and so will contribute different alkalinity to a polysialate precursor. For example, some recycled cementitious materials have calcium oxide, calcium hydroxide, and/or activators that were unreacted when the cementitious material was first hardened. Such materials may have useful calcium oxide content for subsequent use as a polysialate raw material. These recycled cementitious materials can also be mixed, for example to target a desired reactivity or solution pH. These recycled cementitious materials can also be used to provide particle size polydispersity where other raw materials used in a polysialate precursor lack sufficient polydispersity to provide a pumpable mixture when dispersed in water to a target slurry density. A combination of any of the recycled cementitious materials described above can also be used.

Polysialate raw materials that can be used with recycled cementitious materials in a polysialate precursor include (but are not limited to) ASTM Class C fly ash, ASTM Class F fly ash, fly ash not classified by ASTM, volcanic ash, volcanic glass, slag, ferrous slag, ferroalloy slag, non ferrous slag, such as copper slag, nickel slag, tin slag, zinc slag, and the like, blast furnace slag, basic oxygen furnace slag, electric arc furnace slag, and ground slags, such as ground blast furnace slag, ground granulated blast furnace slag (GGBS), diatomaceous earths, pumice, and calcined clays, which may be partially or fully calcined clays (metakaolin is a partially calcined clay), aluminum-containing silica fume, natural aluminosilicate, feldspars, which may be dehydrated, alumina and silica sols, synthetic aluminosilicate glass powder, zeolite, scoria, allophone, bentonite, pumice, red mud, which may be calcined. These materials are mostly aluminum, silicon, and oxygen containing materials that may be, or may include, aluminosilicate materials. Other materials that can be used are ashes produced by combustion of some forest or agricultural industry by-products commonly known as biomass ash, or more specifically biomass fly ash, from various sources such as witchgrass ash, walnut shell ash, rice husk ash, and the like. The more commonly used aluminosilicate materials are fly ash, metakaolin and blast furnace slag. In addition, alumina and silica may be added separately, for example as a blend of bauxite and silica fume. Thus, an alumina-silica mixture can be used with recycled cementitious materials to make a polysialate system. Silica materials such as soda-lime glass dust, borosilicate glass dust, microsilica, fumed silica, precipitated silica, nanosilica, or a combination thereof, can be used with alumina sources and with aluminosilicate sources.

It should be noted that some of the aluminosilicate sources mentioned above, such as GGBS and ASTM Class C fly ash, also contain calcium oxide, so these materials can also be considered activator sources. Suitable aluminosilicate sources for purposes here can have at least 2%, at least 7%, at least 12%, at least 18%, or at least 25% by weight calcium oxide. These aluminosilicate sources become reactive when placed in strongly alkaline environments with recycled cementitious materials, typically at pH greater than 11. The aluminosilicate sources described above react with recycled cementitious materials under such conditions to form polysialate systems. As noted above, in some cases the recycled cementitious material can have compounds such as calcium oxide and calcium hydroxide, along with previously unreacted activators, that raise pH of the water mixture. Binder components such as Portland cement, kaolin, GGBS, fly ash, bauxite, aluminum oxide, and aluminum hydroxide can also be included.

Polysialate precursors herein may include activators that are alkaline materials. Such materials that form water solutions having pH at or above about 11 can activate polysialate raw materials, including recycled cementitious materials, to polymerize in the solution. The activators can be, or can include, alkali metal hydroxides MOH, where M can be Li, Na, K, Rb, or Cs, or combination thereof. The activators can be, or can include, metal silicates M₂ₓSi_{y}O_{2y+x} where x is 1, 2, or 3 and y is 1 or 2 (for example silicates, metasilicates, orthosilicates, and pyrosilicates), where M can be Li, Na, K, Rb, or Cs, or combination thereof. The activators can be, or can include, alkaline earth metal hydroxides, such as Ca (OH) 2, Sr (OH) 2, Mg (OH) 2 and/or Ba (OH) 2; or alkaline earth metal oxide, such as CaO, SrO, MgO and/or BaO or a combination thereof, or alkaline earth metal peroxide, such as MgO₂ and CaO₂ or a combination thereof; with at least one alkali metal salt such as a metal carbonate M₂CO₃, metal sulphate M₂SO₄, metal sulphite M₂SO₃, metal phosphate M₃PO₄, metal oxalate M₂C₂O₄, metal silicate M₂ₓSi_{y}O_{2y+x} where x is 1, 2, or 3 and y is 1 or 2 (for example silicates, metasilicates, orthosilicates, and pyrosilicates), metal fluoride MF, metal hexafluoridosilicate M₂SiF₆, metal iodate MIO₃, metal molybdate M₂MoO₄, where M can be Li, Na, K, Rb, or Cs, where such salts can have a combination of different metals and a combination of different anions. Lime and hydrated lime are examples of materials that contain calcium oxide and/or calcium hydroxide. Hydrogenated metal salts, such as MHCO₃, MHSO₄, MHPO₄, MHC₂O₄, M₂HPO₄, MH₂PO₄, and MHSO₃ can also be used, alone or in combination with other activators described herein, where M is as listed above. The activators can be, or can include, Portland cement, cement kiln dust, cement by-pass dust or a combination thereof.

The activators described above can be added as a dry material to the dry polysialate precursor containing recycled cementitious materials. Alternately, or additionally, the activators described above can be provided in water or alkaline solution and/or dispersion that is mixed with the dry polysialate precursor to form a pumpable polysialate precursor composition. Where the activators are used as dry materials, the activators are typically used in a quantity that is 2 to 40 parts per hundred based on the weight of the dry polysialate precursor, for example 4 to 20 parts per hundred or 4 to 40 parts per hundred based on the weight of the dry polysialate precursor to result in a suitable thickening time, for example time to achieve 70 Bearden consistency units of at least about 2 hours.

The polysialate precursors described herein may include additives and other materials that are unreactive in polysialation reactions or that affect the progress of such reactions. Solid materials that are additives can also be sized to have a particle size distribution that contributes to the packing volume fraction effects described above. Thus the dry polysialate precursor can include an additive that is selected from the group consisting of an accelerator, a retarder, a density modifier, an anti-foam agent, a defoamer, a silica material, a fluid-loss control additive, a viscosifier, a dispersant, an expanding agent, an anti-settling agent, or a combination thereof. Some of these additives have mechanical strength sufficient to undergo at least some sizing processes described herein, along with alkaline reactive materials. Other additives with low decomposition temperatures and/or thermoplastic properties can be added to the dry polysialate precursor after sizing, or can be added to the pumpable polysialate precursor after addition of water. More than one of the additives mentioned above can be included in a polysialate precursor.

Retarders and accelerators can be used to influence thickening time of polysialate precursors made according to the descriptions herein. Retarders such as sodium pentaborate decahydrate, borax, sucrose, boric acid, lignosulphonates, sodium or calcium glucoheptonate, tartaric acid, citric acid, or phosphorus containing compounds such as phosphoric acid, salts thereof, or mixtures thereof can be present in the dry polysialate precursor in amounts of 0.01 to 5 part per hundred by weight of the dry polysialate precursor. Accelerators, for example chlorides of alkali metals and alkaline earth metals, can also be present in a polysialate precursor in amounts up to about 0.01-10, such as 1-5, parts per hundred weight of the dry polysialate precursor. Retarders and accelerators can also be added to water or alkaline solution to be blended with the dry polysialate precursor according to the above amounts.

Density modifiers that can be used include density increasing particles and density lowering particles. Low-density particles may be added to the dry polysialate precursor, or to the pumpable polysialate precursor, to achieve lower slurry densities for a given amount of water added, or heavy particles may be added to achieve higher slurry densities. Slurry density is the bulk density of the pumpable polysialate precursor formed by adding water to a dry polysialate precursor. Slurry density is generally influenced by the amount of liquid added to the dry polysialate precursor, but can be modified using the density modifiers herein. The lightweight or low-density particles may have densities lower than 2 g/cm³, or lower than 1.3 g/cm³. Examples include hollow glass or ceramic microspheres (cenospheres), plastic particles such as polypropylene beads, rubber particles, uintaite (sold as GILSONITE™), vitrified shale, petroleum coke or coal or combinations thereof. The lightweight particles may be present in the compositions at concentrations between about 0.06 kg/L and 0.6 kg/L (20 lb/bbl and 200 lb/bbl). The particle size range of the low-density particles may be between about 38 μm and 3350 μm (6 mesh and 400 mesh). The heavy particles typically may have densities exceeding 2 g/cm³, or more than 3 g/cm³. Examples include hematite, barite, ilmenite, silica (e.g. crystalline silica sand), crushed granite and also manganese tetroxide commercially available under the trade names of MicroMax™ and MicroMax FF™. The density modifier materials that do not have specific shapes (such as hollow particles) can be subjected to sizing processes along with other materials or separately to contribute to the particle size distribution of the dry polysialate precursor.

Fluid-loss control additives can be, or can include, latex, carboxymethyl cellulose, polyanionic cellulose, and/or other water soluble or water dispersible polymers. The latex may be an alkali-swellable latex. The latex may be present in the pumpable polysialate precursor at a concentration between 0.02 L/L and 0.3 L/L or between 0.05 L/L and 0.15 L/L. The latex may be added as a solid material to the dry polysialate precursor, and/or the latex may be dispersed or dissolved in the water or alkaline solution added to the dry polysialate precursor to make a pumpable polysialate precursor. The latex polymer can be, for example, a rubber material such as styrene-butadiene rubber, natural rubber, nitrile rubber, neoprene rubber, and other vinyl polymers. Fluid loss control materials can also include clay materials, such as Bentonite.

Viscosifiers for use herein may comprise diutan gum having a molecular weight higher than about 1,000,000. The diutan gum may be present at a concentration between 0.14 g/L and 1.4 g/L (0.05 lbm/bbl and 0.5 lbm/bbl). In some cases, viscosifiers can be added as a dry material at a concentration of 0.1-5% by weight of the dry polysialate precursor. Other viscosifiers may comprise a polysaccharide material, which may be a biopolymer. Suitable polysaccharide biopolymers can include welan gum, a polyanionic cellulose (PAC), a carboxymethylcellulose (CMC), and combinations thereof. One or more polysaccharide materials, which may be biopolymers, may be present in the dry polysialate precureor at a concentration between 0.14 g/L and 1.4 g/L (0.05 lbm/bbl and 0.5 lbm/bbl). The molecular weight of the polysaccharide material, which may be a biopolymer, may be between 100,000 and 1,000,000. Viscosifiers can be added to the dry polysialate precursor, to the water or alkaline solution used to mix with the dry polysialate precursor, or both.

Expanding agents for use herein may comprise calcium sulphate hemihydrate, metal oxides such as MgO or combinations thereof. These materials can be subjected to sizing operations to contribute to the polydispersity of the particle size distribution of the dry polysialate precursor. These materials can be added to the dry polysialate precursor, or to the water and/or alkaline solution used to mix with the dry polysialate precursor, or both. The expanding agents may be present in the pumpable polysialate precursor at a concentration between 0.01 kg/L and 0.2 kg/L, for example between 0.05 and 0.1 kg/L.

Anti-foaming agents and defoamers can be glycol materials such as propylene glycol and polyethylene glycol. Dispersants such as polynaphthalene sulfonate, acetone formaldehyde sulfonate, melamine formaldehyde sulfonate, and polycarboxylates are commonly used and can be used in the compositions herein.

Recycled concrete can have multiple functions in a polysialate precursor. Recycled concrete can act as a polymerization raw material, polymerizing with other polysialate raw materials to form a polysialate matrix. Recycled concrete can act as an activator to promote polymerization of polysialate raw materials, especially those with more reactivity such as GGBS, which has elevated amounts of calcium oxide. Recycled concrete can also act as a particle size distribution control agent to provide effects emerging from particle size distribution in a polysialate precursor.

The recycled concrete can be sized to one or more particle sizes for reactivity, viscosity control, fluid loss control, or a combination thereof. Concrete can be ground to a target particle size, or to a plurality of target particle sizes, based on a particle size distribution of other solid materials to be used in a polysialate precursor blend. The target particle size can be selected to provide a viscosity effect, to provide a reactivity effect, to provide a fluid loss control effect, or a combination thereof. For example, the recycled concrete can be ground to a state with a particle size distribution that has d50 of about 10 μm to about 20 μm, or about 20 μm to about 50 μm, or about 50 μm to about 100 μm. While larger particles can reduce viscosity of a polysialate precursor blend, smaller particles can reduce loss of fluid from the blend. Recycled concrete can be sized to provide a distribution of particle sizes for the blend, based on particle size distribution of other components of the blend, such as polysialate raw materials, density control materials, and the like, that can make the blend pumpable and can also minimize fluid loss. Thus, a recycled concrete can be a polymerization activator as well as a viscosity control agent and a fluid loss control agent in some cases. Recycled concrete can act as a polymerization raw material, a viscosity control agent, and a fluid loss control agent in other cases. Recycled concrete thus has the capability to be a multifunctional ingredient in a polysialate precursor blend.

Recycled cementitious materials can be used as a polysialate raw material up to 100% of the raw materials. That is, recycled cementitious material, such as recycled cement, recycled concrete, or recycled polysialate, or combination thereof, can be used as the only polymerization raw material in a polysialate precursor blend, along with suitable activators and any desired additives. Recycled cementitious materials, as described above, can also be used with other polysialate raw materials such as GGBS, metakaolin, and other ashes and slags mentioned herein. Thus, for example, the polysialate raw materials can be 65% by weight of recycled cementitious material, such as recycled cement, recycled concrete, recycled polysialate, or combination thereof, with 35% by weight of the raw materials selected from other polysialate raw materials. In other cases, recycled cementitious materials can be 35% by weight of the polysialate raw materials of a polysialate precursor blend, with 65% by weight of other polysialate raw materials. In still other cases, recycled cementitious materials can be 5% by weight of the polysialate raw materials of a polysialate precursor blend, with 95% by weight of other polysialate raw materials. Thus, recycled cementitious materials can be used, along with other polysialate raw materials, at any proportion up to 100% of the polysialate raw materials, in a polysialate precursor blend.

Table 1 below shows polysialate precursors made using recycled cementitious materials using GGBS as an aluminosilicate reactant, and polysialate systems made from such precursors. In Examples 1-3, percentage for GGBS is by volume of blend and other percentages are by weight of blend. In Examples 4 and 5, percentage of recycled polysialate is by volume of blend and other percentages are by weight of blend. Defoamer quantities are gallons per sack.

TABLE 1
TABLE 1 - Polysialate Systems Using Recycled Cementitious Materials.
Condition: 150 F curing in water bath

| Example # | 1 | 2 | 3 | 4 | 5 |
|---|---|---|---|---|---|
| Unused GGBS | 100% | 100% | 100% | — | |
| Recycled Cement | 15% | 7% | — | — | 7% |
| Recycled Polysialate | — | — | 15% | 100% | 100% |
| Alkali Activator | — | — | — | 12% | |
| Retarder | 0.25% | 0.25% | 0.25% | 0.25% | .25% |
| Dispersant | 0.15% | 0.15% | 0.15% | 0.15% | .15% |
| Viscosifier | — | — | 0.04% | 0.04% | |
| Defoamer | 0.02 | 0.02 | 0.02 | 0.02 | 0.02 |
| 24-hr CS, psi | 1,115 | 765 | | | |
| 42-hr CS, psi | | | | | 1,336 |
| 96-hr CS, psi | | | 880 | 3,075 | |

The data of Table 1 shows that recycled cement and recycled polysialate can be used to make polysialate systems having suitable compressive strength. Examples 1 and 2 show that recycled cement can be used, together with unused GGBS, to make a polysialate system without using another alkali activator. Example 3 shows that recycled polysialate can be used in a similar manner. Example 4 shows that recycled polysialate alone can be used as a polysialate raw material. Example 5 shows that recycled cement and recycled polysialate can be used to make a polysialate system without any other raw materials or activators. Examples 1 and 2 also show a trend of increasing compressive strength with an increasing use of recycled cement, illustrating the effectiveness of recycled cement in a polysialation reaction. Thus, recycled cement can be added to a polysialate precursor blend as a compressive strength increasing agent.

While the foregoing is directed to embodiments of the present invention, other and further embodiments of the present disclosure may be devised without departing from the basic scope thereof, and the scope thereof is determined by the claims that follow.

We claim:

1. A dry polysialate precursor composition, comprising:
a recycled cementitious material; and
an aluminosilicate source, an alkaline activator, or both.

2. The composition of claim 1, wherein the composition contains 0.1% to 20% by weight of the recycled cementitious material.

3. The composition of claim 1, wherein the recycled cementitious material comprises a polysialate material, a previously hardened Portland cement, or both.

4. The composition of claim 1, wherein the recycled cementitious material has a particle size distribution selected to provide viscosity control, fluid loss control, increased compressive strength in a polysialate system made from the precursor composition, or any combination thereof.

5. The composition of claim 1, wherein the composition comprises an aluminosilicate source and an alkaline activator.

6. The composition of claim 1, wherein the composition comprises an aluminosilicate source selected from the group consisting of ASTM Class C fly ash, ASTM Class F fly ash, fly ash not classified by ASTM, volcanic ash, volcanic glass, slag, ferrous slag, ferroalloy slag, non ferrous slag, blast furnace slag, basic oxygen furnace slag, electric arc furnace slag, ground granulated blast furnace slag (GGBS), metakaolin, biomass ash, diatomaceous earths, partially or fully calcined clay, aluminum-containing silica fume, natural aluminosilicate, feldspar, alumina and silica sols, synthetic aluminosilicate glass powder, zeolite, scoria, allophone, bentonite, pumice, red mud, an alumina-silica mixture, and combinations thereof.

7. The composition of claim 1, wherein the composition comprises polysialate raw materials consisting essentially of a recycled polysialate material and an aluminosilicate source.

8. The composition of claim 1, wherein the composition comprises polysialate raw materials consisting essentially of a recycled polysialate material and an alkali activator.

9. The composition of claim 1, wherein the composition comprises polysialate raw materials consisting essentially of a recycled polysialate material and a recycled cement.

10. The composition of claim 1, wherein the composition comprises ground granulated blast furnace slag (GGBS).

11. The composition of claim 1, wherein the composition contains 5% to 15% by weight of the recycled cementitious material.

12. A pumpable polysialate precursor composition comprising the dry polysialate precursor composition of claim 1 dispersed in a water solution.

13. A hardened polysialate system made using the pumpable polysialate precursor composition of claim 12 and having a compressive strength of at least about 100 psi.

14. A method, comprising:
obtaining a dry polysialate precursor composition, comprising:
a recycled cementitious material; and
an aluminosilicate source, an alkaline activator, or both;
dispersing the dry polysialate precursor composition in a water solution to form a pumpable polysialate precursor;
pumping the pumpable polysialate precursor into a well; and
allowing the pumpable polysialate precursor to harden in the well to form a polysialate system having compressive strength of at least about 100 psi.

15. The method of claim 14, wherein the dry polysialate precursor composition contains 0.1% to 20% by weight of the recycled cementitious material.

16. The method of claim 14, wherein the recycled cementitious material is a polysialate material.

17. The method of claim 14, wherein the dry polysialate precursor composition comprises an aluminosilicate source and an alkaline activator.

18. The method of claim 14, wherein the dry polysialate precursor composition comprises an aluminosilicate source selected from the group consisting of ASTM Class C fly ash, ASTM Class F fly ash, fly ash not classified by ASTM, volcanic ash, volcanic glass, slag, ferrous slag, ferroalloy slag, non ferrous slag, blast furnace slag, basic oxygen furnace slag, electric arc furnace slag, ground granulated blast furnace slag (GGBS), metakaolin, rice husk ash, diatomaceous earths, partially or fully calcined clay, aluminum-containing silica fume, natural aluminosilicate, feldspar, alumina and silica sols, synthetic aluminosilicate glass powder, zeolite, scoria, allophone, bentonite, pumice, red mud, an alumina-silica mixture, and combinations thereof.

19. The method of claim 14, wherein the dry polysialate precursor composition comprises GGBS.

20. A method, comprising:
obtaining a dry polysialate precursor composition, comprising:
from about 0.1% to about 50% by weight of a recycled cementitious material; and
an aluminosilicate source selected from the group consisting of fly ash, metakaolin, GGBS, or a combination thereof;
dispersing the dry polysialate precursor composition in a water solution to form a pumpable polysialate precursor;
pumping the pumpable polysialate precursor into a well; and
allowing the pumpable polysialate precursor to harden in the well to form a polysialate system having compressive strength of at least about 250 psi.

21. The method of claim 20, wherein the recycled cementitious material is a polysialate material.
